(19) United States
(12) Patent Application Publication
(10) Pub. No.: US 2025/0055270 A1
(43) Pub. Date: Feb. 13, 2025

(54) HYRID CABLE HANGER SYSTEM

(71) Applicant: Maxdao Inc., Plano, TX (US)

(72) Inventors: Junhua Leng, Taizhou (CN); Jie Yuan, Taizhou (CN); Shun Yang, Taizhou (CN)

(21) Appl. No.: 18/231,538

(22) Filed: Aug. 8, 2023

(51) Int. Cl. H02G 3/32; H02G 7/06

(52) U.S. Cl. CPC H02G 3/32; H02G 7/06

(57) ABSTRACT

A cable enclosure system for cables within the communication and power industries. The system can clamp and support a wide range of cables with excellent clamping force and can replace the combination products of cable fixing clamps and rubber variable-diameter sleeves currently on the market.

### FIELD OF THE INVENTION

The present invention relates to a cable clamp enclosure and more particularly to telecommunications enclosures including that can clamp a wide range of power cables, fiber optic cables, or hybrid cables through the design of the clamp body.

### BACKGROUND OF THE INVENTION

Cables are an integral part of modern infrastructure, connecting devices and transmitting data and power signals. Telecommunications systems typically employ a network of telecommunications cables capable of transmitting large volumes of data and voice signals over relatively long distances. Telecommunications cables can include fiber optic cables, electrical cables, or hybrid combinations of varying cables.

However, the management of cables presents numerous challenges, including the risk of entanglement, damage, and movement during short circuit events. A typical telecommunications system usually includes a plurality of telecommunications enclosures integrated throughout the network of telecommunications cables. The telecommunications enclosures or “closures” are adapted to house and protect telecommunications components such as splices, termination panels, power splitters, and wave division multiplexers. Additionally, the cable clamp enclosures must be strong enough to hold the cables during a short circuit event where electromagnetic forces cause the cables to repel each other with extremely high forces.

A Chinese Patent CN215071510U describes a cable clamp assembly that secures the cable bundle to a ladder frame. The cable clamp assembly includes a base and two side bodies. The base is secured to the ladder frame. Two side bodies are pivotally mounted to the ends of the base. Each side body has a first end, an intermediate section and a second end. The first end of each side body includes a mounting member. The mounting member has pegs extending from each side of the mounting member. A stud is mounted in the base to enable the side body to pivot about the cable harness on the ladder frame from an open position to a closed position. The system can hold multiple cables of similar size, but uses a single clamp to attempt to hold multiple cables together. This limits the size and number or cables that can be held to the specific shape of the enclosure.

Chinese Patent CN203732782U describes cable clamp comprising a base having a groove and a gland covering the groove, wherein the gland and the base are detachably connected, The main feature is that the base has a plurality of pointed protrusions on the groove, and the gland has a corresponding gland groove at a corresponding groove portion of the base. The gland recess is just opposite the base recess to form a cavity for securing the cable to effectively conform to the cable surface. Further, the gland recess has a plurality of pointed protrusions thereon. Since the curved surfaces of the base groove and the gland groove are provided with sharp protrusions, the cable can be clamped to make the cable pull-off force>50N, so as to effectively prevent accidental separation or inadvertent movement of the cable. While this system provides a separate holding space for securing each cable, the system's cable sizes are static and cannot be adjusted.

Existing cable clamp systems often suffer from one or more of the following drawbacks: complexity in assembly, insufficient holding strength, inability to accommodate various cable diameters, and lack of versatility in mounting options. As the types and sizes of cables increase in the communication industry, the existing clamp systems in the market are most suitable for fixing cables with a fixed size or smaller sizes. When the size of the cable does not match the clamp, rubber sleeves are often incorporated to compensate for the variable diameter, but this may result in insufficient clamping force. These limitations have created a demand for an innovative cable clamp system that overcomes these challenges, providing enhanced functionality, flexibility, and ease of use.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, there is a need to address the previous problems by having a hybrid cable hanger system that 1) greatly increases the range of cables that can be clamped; 2) adapts to different sizes of cables on both sides; 3) ensures clamping force; and 4) simplifies existing market products, reduces components, and thereby reduces costs and installation errors.

### SUMMARY OF THE INVENTION

The present invention aims to provide a hybrid cable hanger system that has multiple enclosures with each enclosure being able to handle a different size cable. Each enclosure is stackable with other added enclosures. Each enclosure has a center aperture within a circular holder on the exterior of the enclosure coupled to a set of alternating clamp fingers for gripping the cable; and a fastener to apply clamping pressure to the enclosure through the center aperture and sets the variable size of the set of alternating clamp fingers. The tightness of the fasteners sets the distance between the alternating clamp fingers which is the set size for the cable. The fastener comprises a nut and bolt setup.

Furthermore, the circular holder is shaped in a circular zigzag groove pattern to hold the multiple stacked enclosures in place. Similarly, the exterior of the enclosure has a groove cut to allow the serrated grooves to clamp multiple enclosures in a staggered manner when they are tightened. Additionally, the enclosure has both an external reinforcement rib and an internal reinforcement rib to enhance the structural strength of the enclosure. To ensure alignment, the enclosure has a male limiting shaft which fits with an opposing female limiting hole and are symmetrical to prevent the enclosure from being misaligned.

In the preferred embodiment, the stackable enclosure has two sets of alternating clamp fingers on opposite ends of the at least one stackable enclosure for holding a plurality of cables where the center aperture within the circular holder is located between the two sets of alternating clamp fingers. The two sets of alternating clamp fingers on opposite ends may hold the same size cables. However, alternate embodiments include the two sets of alternating clamp fingers on opposite ends hold the different size cables or an embodiment where there is only one set of alternating clamp fingers to hold a single cable. Additionally, a rubber sleeve may be added to compensate for size differences for embodiments where the two sets of alternating clamp fingers on opposite ends may hold the same size cables.

Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference similar features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 illustrates a system for a hybrid cable hanger in accordance with the present invention.

FIG. 2 illustrates a structural analysis diagram of a single-piece variable diameter enclosure of the hybrid cable hanger system in accordance with the present invention.

FIG. 3 illustrates a top-down a single-piece variable diameter enclosure of the hybrid cable hanger system in accordance with the present invention.

FIG. 4 illustrates a top-down view of a single-piece multi-variable diameter enclosure in accordance with the present invention.

FIG. 5 illustrates a top-down view of a single-hole variable diameter enclosure of the hybrid cable hanger system in accordance with the present invention.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification comprises references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

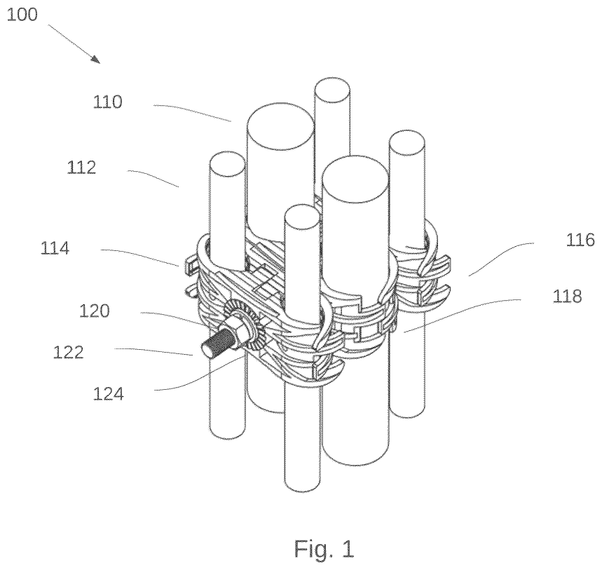

FIG. 1 illustrates a system for a hybrid cable hanger 100 in a stacked configuration, where the same type of cable clamp enclosure can adapt to different cable diameters during installation. The hybrid cable hanger system 100 includes multiple single-piece variable diameter enclosures shown as a first enclosure 114, second enclosure 116, and third enclosure 118. Each enclosure can hold a plurality of cables including a first large size cable 110 and a second smaller size cable 112. The first enclosure 114, second enclosure 116, and third enclosure 118 are coupled together using a fastener. The preferred embodiment uses a nut 120 and bolt 122 setup to secure the enclosures together and ensures a consistent clamping force across all the cables. Each enclosure has a circular zigzag holder 124 on each side to prevent longitudinal or latitudinal sliding. Additionally, the circular zigzag holder 124 allows for the installation of the cable fixing clamp device to be variable. Each enclosure can adapt to a particular size of the cable being held. The system uses multiple enclosures to adapted to two cables of a larger size 110, and two cables of a smaller size 112.

A person having skilled in the art would appreciate that multiple types of fasteners may be used to hold the enclosures together. Although FIG. 1 shows three enclosures in the system, the hybrid cable hanger 100 may have fewer enclosures or a greater number of enclosures. A system may also comprise of a single enclosure. The number of enclosures may be adjusted based on the needs of the network of cables.

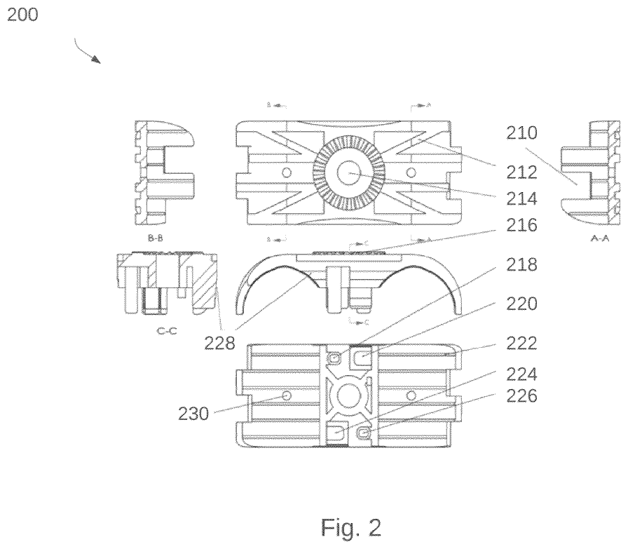

FIG. 2 illustrates a structural analysis diagram of a single-piece variable diameter enclosure 200 of the hybrid cable hanger system. The enclosure contains a circular zigzag holder 216 with a center aperture 214, circular zigzag holder 216 ensures that the two layers of enclosures are positioned relative to each other when stacked, avoiding displacement. Additionally, each side of the enclosure has a groove cut 210 with the function of allowing the serrated grooves to clamp multiple enclosures to be installed in a staggered manner when they are tightened. The external reinforcement ribs 212 and internal reinforcement rib 222 enhance the structural strength of the enclosure and ensures the enclosure is not broken due to the clamping force. The internal reinforcement rib 222 increases the resistance of the contact between the enclosure and the cable, but it does not increase the holding force of the enclosure on the cable;

While circular zigzag holder 214 ensures that the two enclosures are positioned relative to each other when stacked symmetrically, there is still a need to ensure that the two sides of each enclosure are radially correct. Each side of the enclosure has a male limiting shaft 218 and 226 which fits with an opposing female limiting hole 220 and 224. The limiting shaft/limiting hole combination are symmetrically centered providing a limitation to prevent the two sides of the enclosure from being misaligned. The top of each enclosure has a step surface design 228 which to provides greater grip ease when manually installing or removing the enclosure. The step surface design 228 in inwardly declining steps.

In some embodiments, a rubber sleeve may be added to accommodate different size cables within the same enclosure. When the size of the cables on opposing sides of the enclosure are different and one of the cables does not match the clamp, a rubber sleeve is added to ensure the cables on both sides are the same, and the clamping force will meet the requirements. An installation hole 230 provides a reserved position for the installation of rubber parts on the enclosure; The rubber sleeve will have an indent which will fit within the installation hole 230.

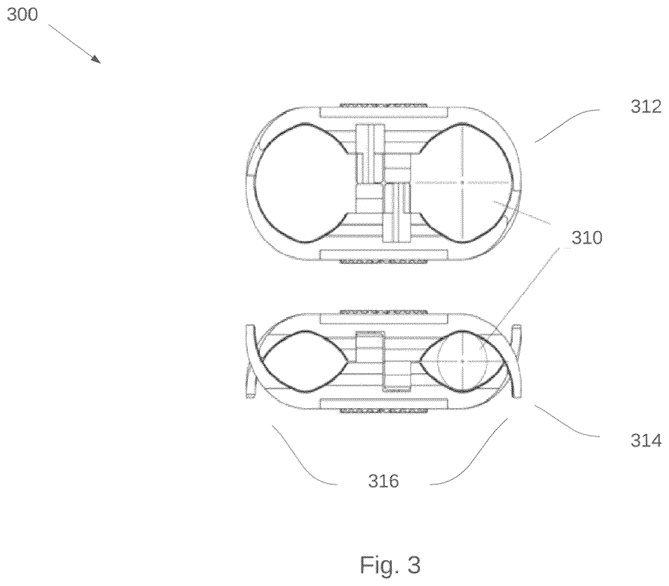

According to the preferred embodiment of the present invention, FIG. 3 illustrates a top-down and side view of a single-piece variable diameter enclosure 300 of the hybrid cable hanger system. Each enclosure 300 comprises two sides that, when combined, provide the clamping force on the cable. Each side has a pair of opposing alternating clamp fingers 316 which grip the cable. This allows each enclosure to handle two cables of the same diameter. In some instances, the alternating clamp fingers 316 intertwine to hold the cable 314 but in larger cables the alternating clamp fingers 232 do not overlap 312. This setup provides each enclosure with the ability to handle variable size cables 310 for each separate enclosure.

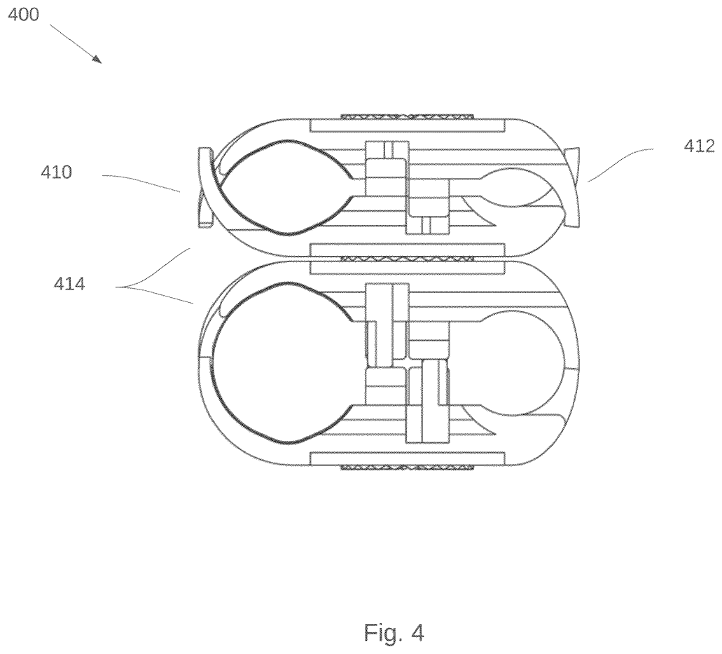

According to the alternate embodiment of the present invention, FIG. 4 illustrates a top-down view of a single-piece multi-variable diameter enclosure 400. There are situations where it would be beneficial for a single enclosure to handle cables of different sizes. In this embodiment, the enclosure 400 can handle cables with different diameters on opposing sides 410 and 412, without the need to add rubber components. The cable diameter can still also be variable 414 but will be dictated but the size ratio difference between the opposing ends of the enclosure 410 and 412.

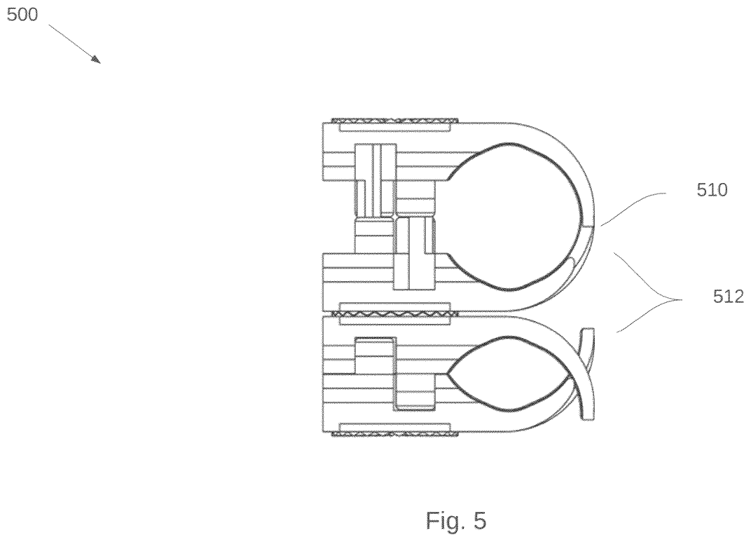

According to the alternate embodiment of the present invention, FIG. 5 illustrates a top-down view of a single-hole variable diameter enclosure 500. There are instances where the enclosure only requires to hold a single cable in contrast to other embodiments with multiple cables. In this embodiment, the enclosure 500 can handle has a single set of alternating clamp fingers 510 for each enclosure. However, the cable diameter can still also be variable 512 between different enclosures.

The hybrid cable hanger system may comprise of different materials including but not limited to polypropylene, nylon or polyoxymethylene. A person having skill in the art would appreciate that other variations of materials may be used to provide the associated benefits such as electrical resistance, tensile strength, and weight.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A hybrid cable hanger system, comprising:
at least one stackable enclosure wherein the at least one stackable enclosure comprises a center aperture within a circular holder on the exterior of the enclosure coupled to a set of alternating clamp fingers for gripping the cable; and
a fastener to apply clamping pressure to the enclosure through the center aperture and sets the variable size of the set of alternating clamp fingers.

2. The hybrid cable hanger system of claim 1, wherein the fastener comprises a nut and bolt setup.

3. The hybrid cable hanger system of claim 1, wherein the circular holder is shaped in a circular zigzag groove pattern.

4. The hybrid cable hanger system of claim 1, wherein the at least one stackable enclosure further comprises an external reinforcement rib and an internal reinforcement rib to enhance the structural strength of the enclosure.

5. The hybrid cable hanger system of claim 1, wherein the exterior of the at least one stackable enclosure further comprises a groove cut to allow the serrated grooves to clamp multiple enclosures in a staggered manner when they are tightened.

6. The hybrid cable hanger system of claim 1, wherein the at least one stackable enclosure further comprises a male limiting shaft which fits with an opposing female limiting hole and are symmetrically to prevent the enclosure from being misaligned.

7. The hybrid cable hanger system of claim 1, wherein at least one stackable enclosure is composed of one of the following materials: polypropylene, nylon, or polyoxymethylene.

8. The hybrid cable hanger system of claim 1, wherein the at least one stackable enclosure further comprises two sets of alternating clamp fingers on opposite ends of the at least one stackable enclosure for holding a plurality of cables; wherein the center aperture within the circular holder is located between the two sets of alternating clamp fingers.

9. The hybrid cable hanger system of claim 8, wherein the two sets of alternating clamp fingers on opposite ends hold the same size cables.

10. The hybrid cable hanger system of claim 9, wherein the two sets of alternating clamp fingers on opposite ends includes a rubber sleeve within one set of the alternating clamp fingers on opposite ends.

11. The hybrid cable hanger system of claim 8, wherein the two sets of alternating clamp fingers on opposite ends hold the different size cables.
